(19) United States
(12) Patent Application Publication
(10) Pub. No.: US 2009/0029012 A1
(43) Pub. Date: Jan. 29, 2009

(54) NON-TRANSPARENT, FAT-IMPERVIOUS FOOD CASING WITH TEXTILE BACKING MATERIAL

(75) Inventors: Jens Foegler, Taunusstein (DE); Herbert Gord, Ingelheim (DE); Michael Seelgen, Idstein (DE); Peter Wolf, Ostercappeln (DE)

Correspondence Address: PROPAT, L.L.C., 425-C SOUTH SHARON AMITY ROAD, CHARLOTTE, NC, 28211-2841, US

(73) Assignee: Kalle GmbH, Wiesbaden (DE)

(21) Appl. No.: 11/913,571

(22) PCT Filed: Apr. 29, 2006
(86) PCT No.: PCT/EP2006/004056

§ 371 Date: May 19, 2008

(30) Foreign Application Priority Data
May 6, 2005 (DE) 10 2005 020 964.5

(51) Int. Cl. A22C 13/00; B65D 81/00

(52) U.S. Cl. 426/105; 426/135; 426/392

(57) ABSTRACT

The invention relates to a tubular food casing with a textile backing material which is coated on the inside with a layer of regenerated or precipitated cellulose. This casing combines the properties of a textile skin with those of a cellulose fiber skin. Aside from the surface texture for which textile skins are known and prized, it features the water-vapor permeability, oxygen permeability and smoke-component permeability of a cellulose fiber skin. At the same time the casing is impervious to fats. It is used preferably as an artificial sausage casing.

The invention relates to a food casing having a textile backing material, a process for production thereof, and also use thereof as artificial sausage casing.

Tubular sausage casings based on regenerated cellulose having an inner reinforcement of fiber paper, in particular of hemp fiber paper, have long been known (see G. Effenberger, Wursthüllen—Kunstdarm [Sausage Casings, Artificial Skin], Holzmann Buchverlag, Bad Wörishofen, 2nd edition [1991] pp. 23/24). These casings generally termed cellulose/fiber skins are generally produced by the viscose process. In this process the fiber paper is first shaped to form a tube with overlapping longitudinal seams which is charged with viscose from the outside, from the inside or from both sides using a ring die. The viscose is then regenerated to cellulose hydrate in a precipitation bath.

Cellulose/fiber skins may also be produced by the more recent amine oxide process. In this process the cellulose is dissolved in aqueous amine oxide, preferably in N-methylmorpholine N-oxide monohydrate. This solution is applied to the fiber paper which is shaped to form a tube. The cellulose is then precipitated in a bath which contains a dilute aqueous amine oxide solution. In this manner a seamless casing may be obtained, as in the viscose process. In contrast to the viscose process, the cellulose in the amine oxide process is not chemically derivatized, but purely physically dissolved. After they are stuffed with sausage emulsion, cellulose/fiber skins are substantially transparent.

It is, furthermore, known to produce tubular food casings from a flat material by corresponding shaping and bonding the longitudinal edges. The bonding can proceed, for example, by gluing, sealing or stitching. The flat material is usually textile material, which can also be coated. The flat material itself can be produced by cutting open a high-caliber tube in the longitudinal direction and dividing the cut-open tube into a plurality of webs of predetermined width. Casings made of such flat material have a particularly uniform extension over their entire periphery.

In addition, acrylic-coated, smoke-permeable textile skins are known (DE-A 31 47 519). The textile material used therein can be a consolidated web, a spun bonded web or a woven fabric made of natural fibers and/or artificial fibers. Those which may be mentioned are fibers of cotton, linen, wool, silk, cellulose esters, regenerated cellulose, polyester, polyamide, polyp acrylonitrile, polypropylene and polyvinyl chloride. The backing material is coated with an acrylic emulsion polymer based on lipophilic esters of (meth)acrylic acid with lower alkanols, in particular butyl acrylate. The coating is applied using conventional coating devices such as air doctor knives, roller doctor knives or rubber cloth doctor knives. Subsequently, the coated web is shaped to form a tube and the longitudinal seam is then sealed by gluing, stitching or sealing. With appropriate selection of the composition of the acrylic coating, the textile skin is water vapor-permeable and gas-permeable and also smokable, so that it is also suitable for long-life sausage.

DE-A 38 26 616 discloses a tubular packaging casing which consists of a textile material coated on both sides with cellulose. It is produced by the viscose process. This casing is substantially transparent, but, however, has interfering spots. Owing to the deficient optical appearance, the product is not ready for the market.

The object was therefore to develop a food casing with a coated textile backing material which no longer has, or has to a much lower extent, the described disadvantages. On the one hand, it is intended to have the surface structure prized in textile skins, i.e. the textile optical appearance thereof, but, on the other hand, it is intended to be fat-impervious. The barrier properties of the casing, that is to say its permeability to water vapor, oxygen and smoke components, shall approximate as close as possible to those of a cellulose/fiber skin. At the same time, the casing must be non-transparent. The casing, finally, shall be more mechanically stable compared with a cellulose/fiber skin of the same weight per unit area, especially have a higher wet tear strength.

The said objects are achieved by a food casing which has a textile backing material which has been coated on one side with a layer of regenerated or precipitated cellulose.

The present invention accordingly relates to a food casing having a flat textile backing material, wherein the textile backing material is coated on the side facing the food with a continuous layer of regenerated or precipitated cellulose. Alternatively, the layer may be applied to the outside and then turned round, so that the layer is then on the inside.

Preferably, the food casing is tubular, particularly preferably, in addition, seamless. “Seamless” designates a casing, the seam of which is scarcely recognizable. The thickening produced on shaping the tube from the textile backing material by overlapping the longitudinal edges is coated with a continuous cellulose coating; therefore, the finished product appears seamless.

If the textile backing material has been pretreated with sizing agents which impair the penetration of the viscose, it must be desized in advance. Sizing agents have also proved to be interfering which dissolve in aqueous precipitation or wash baths. These are, for example, those based on starch or modified starch, mixtures of water-soluble starch and polyvinyl alcohol, in addition, also lubricating agents and lipids. Interfering sizing agents or else interfering preservatives may be removed, for example, by washing or enzymatic treatment. After removal of the sizing agents, the textile backing material frequently exhibits a decreased mechanical stability, that is it can no longer so readily be shaped to form a tube. By impregnation of the backing material, the required mechanical stability may again be achieved,

In a preferred embodiment, the textile backing material is of a quality such that it can take up viscose, or cellulose dissolved in aqueous amine oxide. Suitable materials are natural fibers, in particular those which have a chemical constitution similar or coming close to cellulose, such as cotton, linen or viscose staple. The expression “natural fibers”, in the context of the present invention is also taken to mean fibers of animal origin, such as wool and silk. The natural fibers can, in addition, be mixed with synthetic fibers.

In a further embodiment, textile backing materials made of synthetic fibers are used. The synthetic fibers are produced, for example, from polyester, polyamide, polyacrylonitrile, polyolefin (especially poly-propylene), polyvinyl acetate or polyvinyl chloride. Backing materials made of synthetic fibers are preferably pretreated with chemical and/or physical agents in such a manner that the adhesion of the viscose or amine oxide/cellulose is improved.

The textile backing material is flat and has the form of a woven fabric, knitted fabric, laid fabric, consolidated nonwoven or spun bonded nonwoven. In the laid fabrics or non-wovens, it also always contains relatively long fibers which are several times longer than, for example, in a hemp fiber paper (there the fiber length is generally no more than 5 mm). “Flat” in the context of the present invention is taken to mean relatively thin, but self-supporting materials which may be shaped to form a tube. Thickness and weight per unit area also depend on the intended application of the casing. Generally, the weight per unit area is 8 to 300 g/m², preferably 15 to 200 g/m², particularly preferably 25 to 120 g/m². The textile backing material can be more or less extensible, this likewise depending on the intended application. Non-extensible, or only little-extensible, textile backing materials are expedient for casings in which particularly high caliber constancy is of importance. Particular preference is giver to generally thin, longitudinally and transversely stretched fabric made of cotton, cotton/viscose staple mixtures or viscose staple/polyester mixtures.

The surface properties and the uptake or acceptance capacity of the textile backing material can be adjusted to suit by chemical and/or physical pretreatment. Chemically, for example, by treatment with a melamine/formaldehyde resin, a polyamine-polyamide-epichlorohydrin resin, an acrylic resin (particularly an emulsion polymer based on (C₁-C₆)alkyl (meth)acrylate, especially based on butyl (meth)acrylate. The expression “(meth acrylate” in this case as is customary means “acrylate and/or methacrylate”. The emulsion polymers can additionally contain units of other monomers. These include, for example, units of styrene, α-methylstyrene, maleic acid di-n-butyl ester and/or vinyl acetate. The fraction of units of such other monomers should be less than 25% by weight, preferably less than 15% by weight. Suitable acrylic resins are adequately known to those skilled in the art, for example from DE-A 31 47 519. It has proved to be expedient to treat viscose staple with a melamine/formaldehyde resin or with a polyacrylic. The textile backing material can also be treated with a dilute viscose solution (which as far as possible contains no more than 2% by weight of cellulose xanthogenate) and the viscose is then regenerated to form cellulose. A treatment with a likewise dilute amine oxide/cellulose solution is less technically complex. The derivatized and also non-derivatized cellulose can, if appropriate, be mixed with acrylics. In each case attention must be paid to the fact that the interstitial spaces between the fibers are not completely filled, in order that the (more highly concentrated) viscose or amine oxide/cellulose solution can penetrate unhindered during the actual coating operation. The textile backing material can be pretreated from one or both sides; particularly expediently, it is subjected to Foularding (immersion coating). For this, use is made particularly of usually aqueous dispersions which contain the corresponding organic polymers. The pretreatment, in addition, increases the mechanical stability of the textile backing material, so that it may more readily be shaped to form a tube.

The textile backing material can be dyed or printed. Also, the materials used in the chemical pretreatment can be mixed with dyes and/or color pigments.

Instead of, or additionally to, a chemical pretreatment of the textile backing material, a physical pretreatment can also be carried out. This is, for example, a corona treatment, treatment with plasma, UV rays, gamma rays or a thermal aftertreatment.

For a tubular food casing, the optionally pretreated textile backing material is cut into webs of appropriate width. These webs are each shaped to form a tube, the longitudinal edges of which to a greater or lesser extent overlap. The overlapping region necessary in each case is also determined by the caliber. Generally it is relatively narrow and is 1 to 6 mm, preferably 2 to 4 mm. The textile backing material shaped to form a tube is charged with viscose or an amine oxide/cellulose solution either from the outside, with subsequent turning, or from the inside. In order that the casing remains transparent after it is stuffed, there must be a layer of regenerated or precipitated cellulose at least on its outside. In order to maintain the shape of the tube and to avoid extensive shrinkage on subsequent drying, it has proved to be expedient to charge the tube with supporting air during the coating operation. By regeneration or precipitation, the cellulose layer is formed.

The textile backing material is coated with as much viscose or amine oxide/cellulose solution which, after regeneration or precipitation and washing, forms a closed cellulose hydrate layer. Depending on the type, density and thickness of the textile backing material, this requires about 20 to 250 g of cellulose hydrate, preferably 30 to 150 g, particularly preferably 40 to 120 g, of cellulose hydrate per square meter (dry weight of the cellulose hydrate). The weight of the casing of the invention is thereby (in the dry state) about 60 to 400 g/m², preferably 80 to 300 g/m², particularly preferably 100 to 200 g/m². Expediently, the casing additionally contains a secondary plasticizer, generally glycerol. To ensure that the food casing does not become transparent after stuffing, and at the same time has the textile structure, there is no cellulose hydrate coating on the side facing away from the food.

The food casing of the invention can additionally contain flavor substances or odor substances, in particular those which are transferable to a food situated in the casing. Those which may be mentioned here are, in particular, dry or liquid smoke.

In order to set the correct level of adhesion to the food, the casing is preferably provided with an impregnation on the side facing the food, for example a release or adhesive impregnation. The type and amount of impregnation depend in turn on the type of food.

If the casing is intended to be particularly impermeable to oxygen and/or water vapor, which is necessary, for example, for a liver sausage casing, it additionally has at least one barrier layer on the inside and/or outside. This is, for example, a PVDC layer. Such a casing particularly effectively prevents the sausage from drying out and oxidative discoloration of the sausage emulsion.

The casing of the invention generally has a water content of about 6 to 20% by weight, preferably about 8 to 12% by weight. If it is intended to be ready to stuff without further soaking, it has a moisture fraction of about 20 to 30% by weight. However, it is equally possible to soak a dry casing and then stuff it.

The water vapor permeability of the casing of the invention is generally about 300 to 1500 g/m².d, preferably about 700 to 1200 g/m².d. The oxygen permeability at 65% relative (humidity on the basis of a 5 cm² size piece of the casing having water content of 8 to 10% by weight and a plasticizer content of about 15% by weight is generally about 20 to 100 cm³/m².d. The water permeability is finally about 70 to 200 l/m².d, preferably about 80 to 120 l/m².d, measured in each case at 40 bar of internal pressure.

The casing is usually smoke-permeable. However, if it has additional barrier layers, then it is generally impermeable to cold or hot smoke. The extension behavior of the casing of the invention is essentially determined by the type and thickness of the textile backing material and also by the weight of the cellulose hydrate layer and any further layers present. It can vary between 0.1 and 25%, preferably between 1 and 10%.

Processes and devices for producing the casing of the invention are known in principle to those skilled in the art. For this, first a flat textile backing material is prepared. Sizing agents, if appropriate, are removed from the backing material. If necessary or desired, the backing material can be treated with an impregnating agent which modifies its surface properties and/or improves its mechanical strength. If a seamless product is to be produced, the backing material is shaped to form a tube. The tubular or flat backing material is then charged from one side with a continuous layer of viscose or an amine oxide/cellulose solution. This can be performed, for example, by doctor knife application, roller application, application using an annular die or sheet die or using other coating devices which are familiar in principle to those skilled in the art. Thereafter, the cellulose is coagulated from the viscose in an acidic precipitation bath and regenerated. Alternatively, the cellulose is precipitated from the amine oxide/cellulose in a bath of a dilute aqueous amine oxide. In both embodiments, the material is then washed and dried, if appropriate also further end-processed.

The casing may be produced in tile form of a flat web or equally as a tube. The tube can subsequently be sliced open in the longitudinal direction and if appropriate divided into two or more correspondingly narrower webs. These can in turn be shaped to form tubes of a smaller caliber, wherein the longitudinal edges are bonded to one another permanently by gluing, sealing, stitching or in another manner familiar to those skilled in the art. By means of appropriate cutting to size or bonding the longitudinal edges, tubular casings having variable diameter or irregular contours can also be produced. In this manner, the shapes of a natural skin may be imitated.

After the coating, the cellulose, as described, is regenerated or precipitated. The casing in flat form can in subsequent steps be impregnated, provided with a further coating (for example a barrier layer) and/or printed. If necessary, the casing of the invention is sliced in flat form into webs of appropriate width. The webs are then brought into a tubular form and the overlapping longitudinal edges fixed, for example by gluing, sealing, welding or stitching. For production of a glued seam, for example, hot melts or reaction adhesives, for example polyurethane or ethylene/vinyl acetate adhesive may be used.

The tubular food casing of the invention with or without a seam may be stuffed without problems with pasty foods, such as sausage emulsion, using customary stuffing machines. When used as sausage casing, it is expediently pushed onto the stuffing tube in shirred form (as what is termed a shirred stick). Sections closed at one end can also be stuffed. The end closure can in this case be produced by a metal or plastic clip (which can also be connected to a loop for suspending the sausage), by binding with yarn, by knotting, gluing, sealing (wherein generally a flat seam is formed which can be straight, inclined, wavy or irregularly shaped) or produced by stitching. A plurality of said types of closure can also be combined. The sections are pushed individually onto the stuffing tube, stuffed with the pasty food, in particular with sausage emulsion, and closed. Further processing can then proceed as customary by scalding, boiling or smoking. The tubular casing of the invention may particularly advantageously be used as artificial sausage casing, more particularly not only for raw sausage (such as air-dried or mold-ripened salami) but also for scalded-emulsion or cooked-meat sausage. The casing of the invention may additionally be used for packaging cheese.

If desired, the tubular food casing of the invention can be covered with a net which comprises, for example, honeycomb-shaped, octagonal, square or rectangular structures. The net, if appropriate, is also elastic.

The examples hereinafter are intended to illustrate the invention. Percentages herein are percentages by weight, unless stated otherwise or is clear from the context.

### EXAMPLE 1

A fabric of 100% viscose staple having a weight per unit area of 58 g/m² was coated by the viscose process on the inside with colorless cellulose. The resultant total weight was 114 g/m². The casing was then tied off and stuffed with salami emulsion and ripened for 12 days. The textile structure of the casing remained clearly visible after this time. The casing was practically non-transparent, thus having the appearance of a conventional textile skin.

### EXAMPLE 2

A blended textile composed of 80% cotton and 20% polyester with weight 102 g/m² was coated from the outside by the viscose process. The casing was then turned and shirred, stuffed with salami emulsion, and smoked. Total ripening time was 19 days. After this time, the textile structure of the casing was clearly visible and its appearance was as desired. The casing was practically non-transparent.

1. A food casing comprising a flat textile backing material, wherein the textile backing material is coated, on the side facing a food, with a continuous layer of regenerated or precipitated cellulose.

2. The food casing as claimed in claim 1, wherein said food casing is tubular.

3. The food casing as claimed in claim 1, wherein the textile backing material is flat and comprises a woven fabric, knitted fabric, laid fabric, consolidated nonwoven or spun bonded nonwoven.

4. The food casing as claimed in claim 1, wherein the textile backing material comprises natural fibers and/or synthetic fibers.

5. The food casing as claimed in claim 1, wherein the textile backing material has a weight of 8 to 300 g/m².

6. The food casing as claimed in claim 1, wherein said food casing has a total weight in the dry state of about 60 to 400 g/m².

7. The food casing as claimed in claim 1, wherein the surface properties and the uptake ability of the textile backing material are modified by a chemical and/or physical pretreatment.

8. The food casing as claimed in claim 7, wherein the textile backing material is impregnated with melamine/formaldehyde resin, hydroxypropylated starch ether, copolymers having units of vinyl acetate, acrylic resins, polyamine-polyamide-epichlorohydrin resins, or dilute viscose.

9. The food casing as claimed in claim 1, wherein the textile backing material is colored with dyes and/or coloring pigments.

10. The food casing as claimed in claim 1, wherein, after said food casing is stuffed with a food, said food casing is not transparent.

11. The food casing as claimed in claim 1, wherein said food casing is tubular and, on the inside, has an impregnation or coating which influences the food casing adhesion to the food.

12. The food casing as claimed in claim 1, wherein the coated textile backing material is sliced into flat webs which are shaped to form a tube by gluing, stitching, or sealing.

13. The food casing as claimed in claim 12, wherein the flat webs are cut or longitudinal edges are bonded to produce casings having variable diameter or irregular contours that imitate a natural skin.

14. The food casing as claimed in claim 1, wherein the coated textile backing material is present as a tube which is additionally stitched to improve the optical appearance.

15. The food casing as claimed in claim 1, wherein said food casing is coated with a net which comprises honeycomb-shaped, octagonal, square or rectangular structures, and optionally is elastic.

16. The food casing as claimed in claim 1, wherein said food casing is end-processed to form sections, tied-off sections or shirred sticks.

17. A process for producing a food casing as claimed in claim 1, said process comprising the following steps in the sequence given:
a) providing a flat textile backing material;
b) optionally removing a sizing agent;
c) optionally treating the textile backing material with an impregnating agent in order to modify the textile backing surface properties, uptake capacity and/or mechanical strength;
d) optionally shaping the textile backing material to form a tube;
e) charging the whole surface of one side of the textile backing material with viscose or amine oxide/cellulose solution;
f) coagulating and regenerating the cellulose from the viscose or precipitating the cellulose from the amine oxide/cellulose solution to form a cellulose hydrate layer on the textile backing material;
g) washing the coated textile backing material,
h) optionally treating the food casing with a secondary plasticizer
i) optionally impregnating the food casing with an adhesive and/or release preparation;
i) drying the coated textile backing material and
k) optionally end-processing the food casing.

18. Raw sausage casing, scalded-emulsion sausage casing, cooked-meat sausage casing, or packing for cheese comprising the food casing as claimed in claim 1.

19. The food casing as claimed in claim 2, wherein said food casing is seamless.

20. The food casing as claimed in claim 4, wherein (i) the natural fibers are cotton, linen, viscose staple, wool and/or silk and (ii) the synthetic fibers are polyester, polyamide, polyolefin, polyvinyl acetate, polyacrylonitrile, polyvinyl chloride, or copolymers therof.

21. The food casing as claimed in claim 5, wherein the textile backing material has a weight of 15 to 200 g/m².

22. The food casing as claimed in claim 5, wherein the textile backing material has a weight of 25 to 120 g/m².

23. The food casing as claimed in claim 6, wherein the total weight of said food casing in the dry state is about 80 to 300 g/m².

24. The food casing as claimed in claim 6, wherein the total weight of said food casing in the dry state is about 100 to 200 g/m².

25. The food casing as claimed in claim 8, wherein the copolymers having units of vinyl acetate are vinyl acetate/maleic acid di-n-butyl ester copolymers and the acrylic resins are emulsion polymers having units of (C₁-C₆)alkyl (meth)acrylates.
